(19) United States
(12) Patent Application Publication
(10) Pub. No.: US 2008/0185109 A1
(43) Pub. Date: Aug. 7, 2008

(54) REELING DEVICE FOR CURTAIN CORDS

(76) Inventor: Ker-Min Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/670,493

(22) Filed: Feb. 2, 2007

(51) Int. Cl. E06B 9/322

(52) U.S. Cl. 160/170

(57) ABSTRACT

A reeling device for curtain cords has multiple dual-layer guiding wheels arranged in line and multiple S-shaped resilient coils. Two adjacent guiding wheels are meshed with each other by gear teeth. Each guiding wheel has a cord winding thereon so that the cords can be operated synchronously. Each S-shaped resilient coil is secured on two adjacent guiding wheels and provides the resilient force to balance the curtain weight. Therefore, the cords are adapted to longitudinally attach on the curtain and to control the extension or contraction of the curtain.

### BACKGROUND OF THE INVENTION

1. Field of the Invention

The present invention relates to a reeling device for curtain cords and, more particularly, to a reeling device that has multiple dual-layer guiding wheels adjacently meshed in line by teeth and synchronously receiving curtain cords in balance.

2. Description of Related Art

Conventional reeling devices for curtain cords are designed to show no interior equipment emerging from a casing so that the reeling device has a neat appearance and is safe in operation.

One of the conventional reeling devices is particularly designed to collect a plurality of cords according to a curtain width and to keep the operation of the curtain in balance, because wider curtains need more cords to keep the curtain in horizontal status and proper extension. Weight of the curtain is supported by a resilient force provided by multiple S-shaped resilient coils attached between two adjacent driving wheels. Thus, users can pull the curtain and suspend the curtain at any desired height.

The conventional reeling device substantially includes multiple guiding wheels for cords and multiple driving wheels for resilient coils respectively. Therefore, each wheel only has one function and selectively engages with the cord or the resilient coil. Because of this drawback, the driving wheels are all arranged in line at the middle and two cord wheels are attached at two ends so that each conventional reeling device only can control two cords to suspend the curtain. If the curtain width is large and needs more cords, multiple sets of the reeling devices are needed. Thus, assembly cost for the curtain is significantly increased. Those defects are caused by the bad design of the conventional reeling device.

### SUMMARY OF THE INVENTION

A main objective of the present invention is to provide a reeling device for curtain cords that operates multiple cords synchronously, stably and efficiently by one set only.

Another main objective of the present invention is to provide a reeling device that reduces manufacturing cost thereof.

To achieve the foregoing objectives, the reeling device for curtain cords comprises:

two plates;

multiple guiding wheels clamped between the two plates, each guiding wheel has a disk with a toothed periphery, a reel formed on one side of the disk to selectively receive a cord and a shaft formed on the other side of the disk; and

a S-shaped resilient coil mounted on adjacent two of the multiple guiding wheels;

wherein, the multiple guiding wheels are meshed one by one to rotate synchronously.

By having the reel and the shaft on two sides of the disk, each guiding wheel includes the S-shaped resilient coil and the cord simultaneously mounted thereon to increase versatility of the reeling device in use.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a blind assembly combined with a reeling device in accordance with the present invention;

FIG. 2 is an exploded perspective view of a dual-layer guiding wheel in the reeling device in accordance with the present invention;

FIG. 3 is a perspective view of a first embodiment of the reeling device in accordance with the present invention;

FIG. 4 is a cross-sectional top view of the reeling device in FIG. 3;

FIG. 5 is a front view of the reeling device in FIG. 3;

FIG. 6 is a cross-sectional top view of a second embodiment of the reeling device in accordance with the present invention; and

FIG. 7 is a front view of the reeling device in FIG. 6.

### DETAILED DESCRIPTION OF THE PREFERRED EMBODIMENT

A reeling device for curtain cords in accordance with the present invention includes multiple dual-layer guiding wheels arranged in line, multiple S-shaped resilient coils and multiple optional axle wheels. Two adjacent guiding wheels are meshed with each other by gear teeth and each guiding wheel has a cord winding thereon opposite to one on another corresponding guiding wheel combined by the S-shaped resilient coil so that the cords can be operated synchronously. Each S-shaped resilient coil secured on two adjacent wheels also provides the resilient force to balance the curtain weight. Therefore, the cords are adapted to longitudinally attach on the curtain and to control the extension or contraction of the curtain.

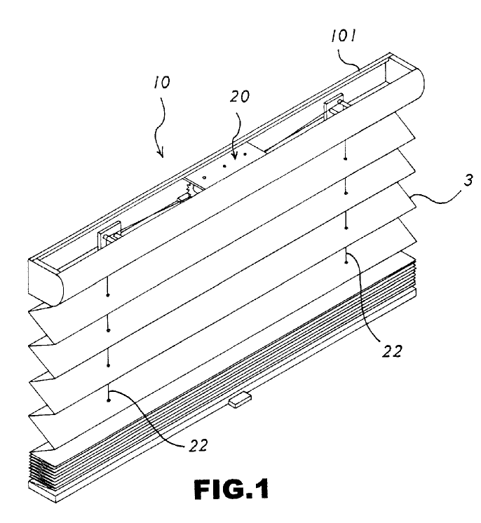

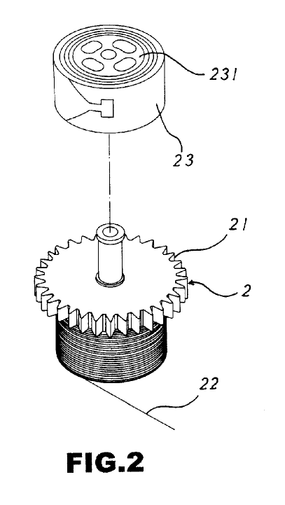

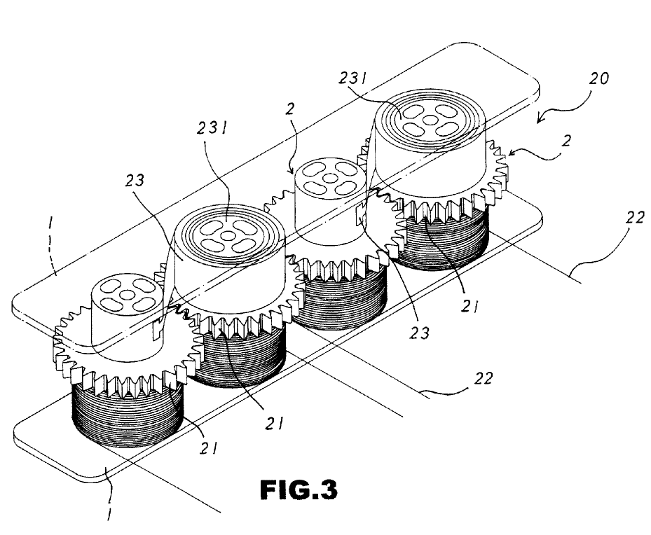

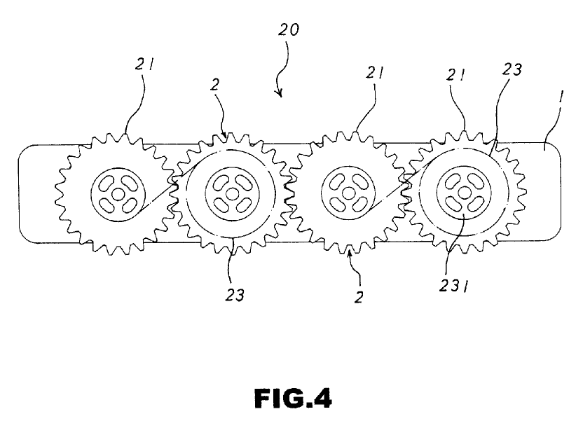

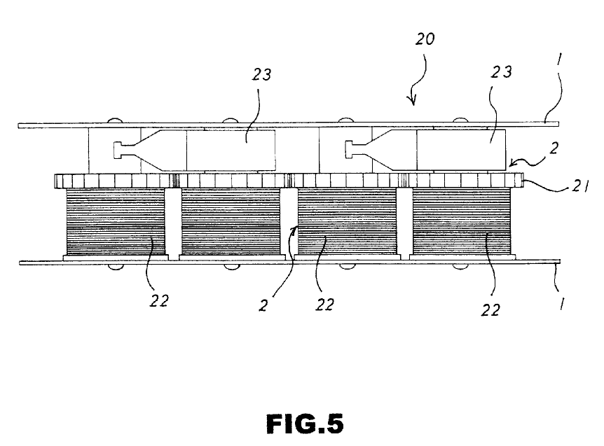

With reference to FIG. 1, a first preferred embodiment of the reeling device 20 is adapted to attach to a frame 101 for a blind assembly 10 as shown (other curtains are applicable) to extend or contract multiple slats 3 of the blind assembly 10. The reeling device 20 includes two plates 1 mounted on the frame 101 and multiple guiding wheels 2 rotatably clamped between the two plates 1. As shown in FIG. 2, each guiding wheel 2 has a middle disk with a toothed edge 21 to mesh with adjacent guiding wheels 2 to move synchronously. A reel (not numbered) is formed on one side of the middle disk for collecting a cord 22, and a shaft (not numbered) is formed on the other side of the middle disk. Therefore, two compartments are defined when the guiding wheel 2 is clamped between the two plates 1 to make the guiding wheel 2 in the form of a dual-layer. As shown in FIG. 3, a S-shaped resilient coil 23 is attached to two adjacent guiding wheels 2 at two distal ends and provides resilient force to balance the weight of the slats 3 so that a user is able to suspend the curtain at any desired height. Preferably, the cords 22 on the two adjacent guiding wheels 2 are wound clockwise and counterclockwise, respectively, to attach to the slats 3 in parallel when the resilient coil 23 is S-shaped as shown in FIGS. 3 to 5.

By having the foregoing components, each guiding wheel 2 in the reeling device 20 selectively receives the cord 22 and interacts with an adjacent guiding wheel 2 by the S-shaped resilient coil 23. Moreover, the toothed edge 21 on the middle disk ensures the interactive rotation of the guiding wheel 2 to be stable and efficient.

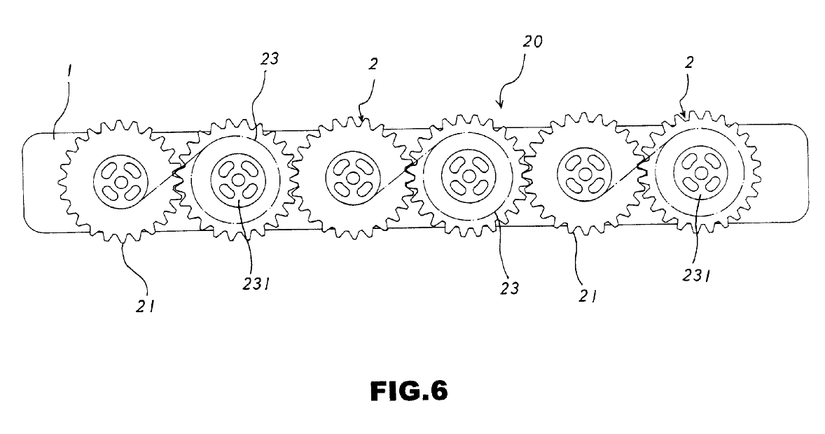

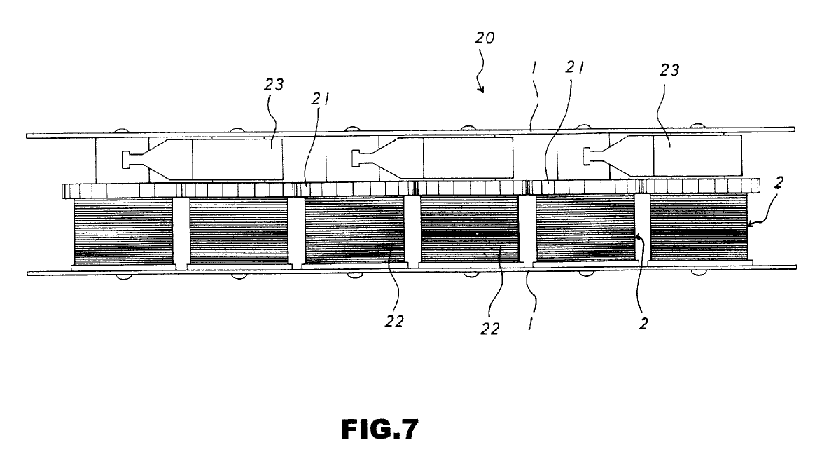

A second preferred embodiment of the reeling device as shown in FIGS. 6 and 7 includes six guiding wheels 2 and three S-shaped resilient coils 23 to increase the number of cords 22 (6 in maximum) when width of the slats 3 is increased. The cords 22 on the reeling device 20 longitudinally extend to string the slats 3 with proper intervals to move the slats 3 synchronously in balance during operation. Because the resilient force of the S-shaped resilient coils 23 on the paired guiding wheels 2 correspond to the weight of the slats 3, the cords 22 are pulled to drive the paired guiding wheels 2 to deform the S-shaped resilient coils 23 by interaction of the toothed edge 21 to provide the resilient force. Therefore, each cord 22 extends or retracts by providing the resilient force of the S-shaped resilient coil 23. Moreover, the resilient force of the S-shaped resilient coil 23 also provides a positioning efficiency to the slats 3, because the resilient force corresponds to the weight of the slats 3.

Additionally, each S-shaped resilient coil 23 mounted on the paired guiding wheels 2 has one distal end attached to a drum 231 pivotally mounted on the shaft of one of the guiding wheels 2. The distal end of the S-shaped resilient coil 23 penetrates the drum 231 to be secured on the corresponding guiding wheel 2 and further winds on the drum 231. Since the drum 231 is freely and rotatably mounted on the guiding wheel 2, the S-shaped resilient coil 23 can automatically adjust the resilient force to be equal to the weight of the slats 3 during operation.

The S-shaped resilient coil 23 provides not only the transmission efficiency to pull or release the cords 22 but also the resilient force to keep the slats 3 in balance when the blind assembly is raised or lowered.

According to above description, the reeling device 20 for curtain cords 22 has the following advantages:

1. Each guiding wheel 2 can have the resilient coil 23 and the cord 22 to possess two functions and to increase variation of the reeling device in adjusting numbers of wheels 2 and, particularly, numbers of cords 22. Unlike the conventional reeling device having two cords 22 only, the reeling device in the present invention is selective to have multiple cords 22 to correspond to a widened curtain. Therefore, only one set of the reeling device is applied to the curtain and product cost is, thus, reduced.

2. The guiding wheels 2 in the reeling device are uniform so that manufacturing process and combination of the reeling device are simplified and standardized to save more cost and time.

3. The middle disk with toothed edge 21 makes the transmission of the guiding wheel 2 stable to wind up the multiple cords 22 synchronously and to prevent the cords 22 from tangling with each other inside the frame 101.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A reeling device for curtain cords, comprising:
two plates;
multiple guiding wheels clamped between the two plates, each guiding wheel has a disk with a toothed periphery, a reel formed on one side of the disk to selectively receive a cord and a shaft formed on the other side of the disk; and
a S-shaped resilient coil mounted on adjacent two of the multiple guiding wheels;
wherein, the toothed periphery of the multiple guiding wheels are meshed one by one to rotate synchronously.

2. The reeling device as claimed in claim 1, wherein the S-shaped resilient coil has one distal end penetrating a drum secured on one of the adjacent two of the multiple guiding wheels and winding on the drum rotatably mounted on a shaft of the guiding wheels.

3. The reeling device as claimed in claim 2, wherein the S-shaped resilient coil has another distal end penetrating a drum to secure on another of the adjacent two guiding wheels and winding on the drum that is rotatably mounted on a shaft of the other of the adjacent multiple guiding wheels.
